(19) United States
(12) Patent Application Publication
(10) Pub. No.: US 2020/0272609 A1
(43) Pub. Date: Aug. 27, 2020

(54) Method for dividing the data based on a persistent data queue

(71) Applicant: VIETTEL GROUP, Ha Noi City (VN)

(72) Inventors: Van Duong Nguyen, Ha Noi City (VN); Tuan Anh Pham, Ha Noi City (VN)

(73) Assignee: VIETTEL GROUP, Ha Noi City (VN)

(21) Appl. No.: 16/669,167

(22) Filed: Oct. 30, 2019

(30) Foreign Application Priority Data
Feb. 22, 2019 (VN) 1-2019-00916

(51) Int. Cl. G06F 16/21; G06F 16/27

(52) U.S. Cl. CPC G06F 16/217; G06F 16/278

(57) ABSTRACT

The invention proposes a method for dividing archived data based on persistent queue (PQ), including i) dividing this stored data into persistent data queues corresponding to the time it needs to be processed in the future; ii) scheduling the processing of data that has been split into these persistent data queues corresponding to future milestones; and iii) redistribute stored data into new sustainable data queues corresponding to the next time it takes for further processing of this data.

### TECHNICAL AREAS ARE MENTIONED

The invention relates to the method of dividing the data stored on a persistent data queue (persistent queue—PQ) to serve for handling packages extend over short periods to limit scans of the entire database, minimizing the performance impact as well as leading to the stable operation of the system.

### TECHNICAL CONDITION OF THE PRESENT INVENTION

In the charging system in real time (Online Charging System—OCS), one of the important businesses of this system is the extension of the tariff plan periodically. There are packages to be handled in the long term renewal each week, each month, but also the need to handle packages extended by the hour or every minute.

To solve the problem of renewal mentioned above, most of the known OCS systems, are choosing the option of scanning the entire data package on the database of the system, filtering out the data package to satisfy the certain conditions and handling extension for that packages. With this method, each time the handle is extended, the system retrieves the entire data package customer in the database to perform checking, to find out what data packages meet the condition and processing renewal. Although the number of data matching filter conditions is minimal, but the need to use too many resources of the database in the process, affecting the stability and processing performance of database and affecting the processing performance of the entire system.

Due to the direct impact to the resource database of the system, the professional extension of the period often is designed to be scheduled to run at the time the actual system load is low, such as the night in which the number of real-time transaction for charging system is relatively low. Therefore, to design the system to solve the problem of flexibility to the professional renewal of the period with high precision than, in hours, minutes (ie the data should be taken to renew each 9am daily, or data needs to be renewed every 30 minutes), the solution used to scan data directly in the database is not currently meet.

### TECHNICAL NATURE OF THE INVENTION

Therefore, to overcome the above problems, the invention proposes a method to divide data based on persistent data queues (persistent queue—PQ) including:
i) divide this data into the persistent data queues corresponding to the processing time required in the future;
ii) scheduling processing of the data has been distributed into the persistent data queue corresponding timelines in the future; and
iii) redistributing data to the new persistent data queue corresponding to the time it takes for the next renewal of the data.

A method according to the invention to store data in the persistent data queue corresponding to timelines required to schedule renewal in the future. Thus, the data to be processed will be found more quickly and it is not needed to scan a database to check processing.

### BRIEF DESCRIPTION OF THE DRAWINGS

To describe the invention more clearly, the following briefly describes the accompanying drawings required for describing the invention.

FIG. 1 is a flow diagram describing updating and dividing the data into the persistent data queue (persistent queue—PQ) according to the invention.

FIG. 2 describes how to organize data by time of persistent data queue.

FIG. 3 shows the logic diagram processing method extension data distribution system based on persistent data queue according to the invention.

FIG. 4 describes the sequence diagram (Sequence Diagram) of renewal professional method data distribution system based on persistent data queue according to the invention.

FIG. 5 is a drawing describing an example implementation of the invention as has been applied in the system's real-time charging Viettel (Online Charging System—vOCS Viettel).

### A DETAILED DESCRIPTION OF INVENTIONS

Charging systems in real time, to ensure the renewed policy can be met in a flexible way without affecting the stability of the system, there is a need to renew professional use limited resources database of the system. The solution according to the invention to overcome this problem is to not use the scanner manipulating the database to retrieve a list of packages, that need to handle extended use persistent queue data to divide and store the data to be renewed since the data is created or updated, until renewal just takes the data from the persistent data queue to process.

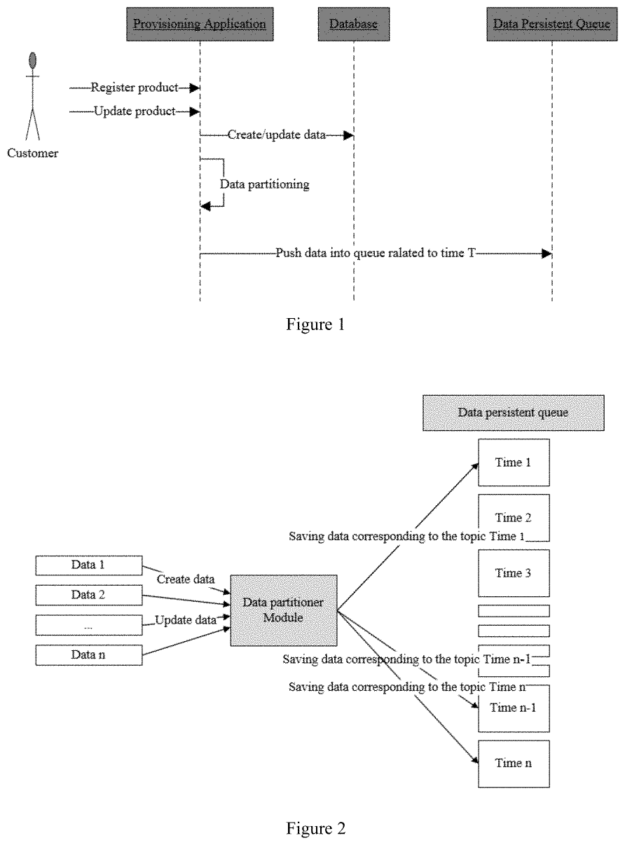

FIG. 1 is a flow diagram describing update and divide the data into the persistent data queue (persistent queue—PQ) according to the invention. As shown in FIG. 1, right from when customers register the package at the time T, the data package will be stored in the database, and, based on the requirements of cyclical renewal package (renewed each month, renew every 30 days, renewed every 7 days, renewed every 24 hours or every 1 hour), the moment the package to be renewed will be determined before Tₙₑₓₜ=f(T,data).

A data division block will determine the time Tₙₑₓₜ (corresponding to which persistent data queue) to store the key of data in that queue_Tₙₑₓₜ package in line.

FIG. 2 describes how to organize data by time of persistent data queue. As shown in FIG. 2, when customers register the package at the time of 10 hours 15 minutes, 05 th day of the month, data of package1 (data1) corresponding with key of package1 (key1) is saved to the database. Under the policy, that package should be extended once every 24 hours. Meanwhile, the key of data1 is key1 will be stored in a data queue persistent named RecurringMsgQueue_06_10h15m corresponding time of 10 hours 15 minutes, 06th day of the month (after 24 hours from the time of registration).

Also at that time, another customer registration package2 (data2) with key is key2, policies to be renewed every 3 hours, then key of data2 is key2 is stored in queue persistent data RecurringMsgQueue_05_13h15m relative corresponding to the time of 13 hours 15 minutes on the same day (after 3 hours from the time of registration).

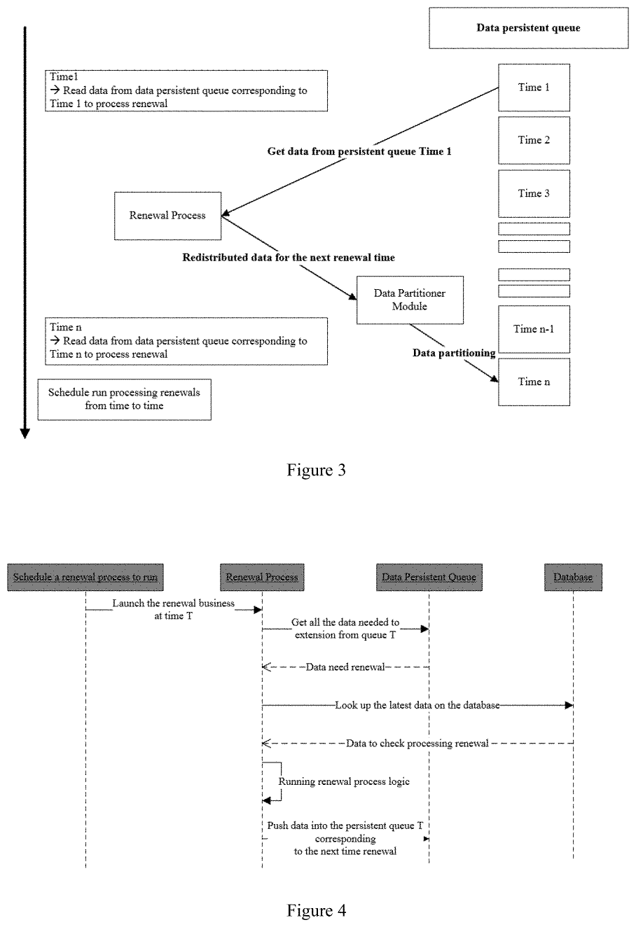

FIG. 3 shows the logic diagram processing method extension data distribution system based on persistent data queue according to the invention. As shown in FIG. 3, at each time of launch renewed business cycles, data need extended availability has been split into a persistent data queue is read out and handle extended.

Based on the time of the renewal process, corresponding to the time T, determine the corresponding persistent data queue containing the key list of packages to be extended.

For example, the runtime renewal T is 10h13 on Thursday, 6 in May, identified queue persistent data contains information of data to be processed renew RecurringMsgQueue_06_13h15m (corresponding period of the queue near the time processing time to run the most extended).

The key of the data package to handle the extension will be read from the data queue persistent. The renewal unit retrieves the package information from the database based on the keys it receives and processes the package renewal. After processing the renewal done per package, this data will be transferred to the data division block to continue dividing into the next persistent data queues to serve the problem of renewal in the future time Tₙₑₓₜ. The method of determining when Tₙₑₓₜ is similar to determining the time to renew when customers register the package. Thus, the problem of renewal are met in a flexible manner without using more resources database. At the same time, the amount of data to check for renewal is much less, helping the renewal process to be processed faster, ensuring system performance as well as meeting the extended renewal problems in short period.

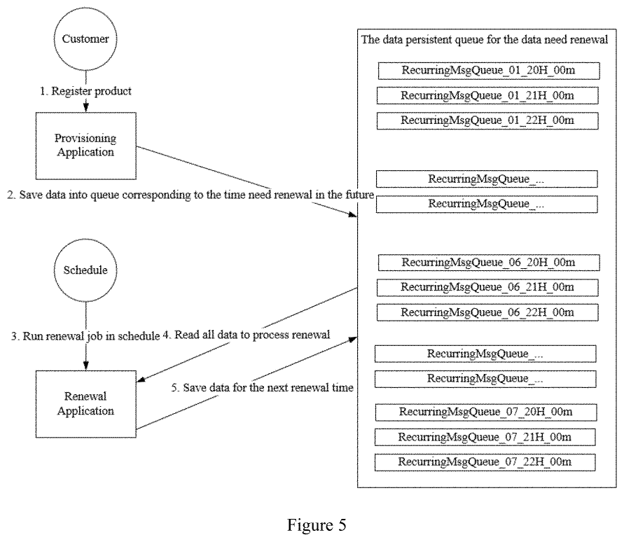

FIG. 4 depicts the sequence diagram (Sequence Diagram) of the business processing by the method of dividing the system based on persistent data queue according to the invention. As shown in FIG. 4, the data that has been retrieved from the persistent data queue is obsolete, the renewal business unit needs to interact with the database to retrieve the latest data to ensure accurate handling of renewal operations.

### EXAMPLE OF IMPLEMENTATION INVENTION

A method according to the invention has been applied to the problem of accurate billing hourly billing system in real time vOCS. The problem of charging the exact time requested a group of subscribers enjoying promotion policy A, within the period of 20 hours-21 hours, subscriber can enjoy the policy of using free data, be notified and sent to the promotion time frame and accurately charged at the time of 20 hours and 21 hours if you are accessing update data at that time. As shown in FIG. 5, details the steps as follows:

### Step 1:

When customers are registered for promotion A on the 6th of the month, the Provisioning application will store customer information in the persistent data queue RecurringMsgQueue_20H_00m.

### Step 2:

At the right time 20h00, the Recurring applications will read data from this RecurringMsgQueue 06_20H_00m queue, retrieve the subscribers that need to be extended at this time and process renewal, send messages, split charges due to the changes of policy.

### Step 3:

After the renewal process is completed, the Recurring application will store the newly processed customer information into the RecurringMsgQueue_06_21H_00m queue.

### Step 4:

Recurring applications running at the time of 21h00 will handle messaging, separating charges by policy changes at 21h00 to subscribers, and push back in RecurringMsgQueue_07_20H_00m to schedule time for renewal on the next day 20h00 further processing operations.

### Evaluation of the Processing Time:

If you use the solution of scanning all data of 80 million subscribers to search for qualified subscribers to send messages and split rates, the processing time will range from 45 minutes to over 1 hour, in which, database scan time takes up to over 40 minutes.

Whereas if using the solution mentioned in the invention, the implementation time is less than 5 minutes (due to the number of subscribers satisfying the handling conditions is not much).

The proposed solution does not require database scanning, so shortening the time to handle the extended problem to 5 minutes (only including the time to perform the operation).

### Evaluation of the Impact the System:

Scanning databases greatly affects online transactions such as making calls, sending SMS messages, accessing data by using a lot of system resources, especially during rush hour from 20:00 until 21:00.

Meanwhile, the solution proposed according to the invention does not perform database scanning, so it does not affect the online services.

### THE ACHIEVED EFFECT OF THE INVENTION

The effectiveness of the invention is to divide the system data based on a persistent data queue to meet the flexibility of flexibly processing short-term renewal problems:

Solve renewal problems without dealing with database scans.

Help the system handle the extension problem faster, minimize the impact of the renewal operation on the performance and stability of the system.

Flexibly support handling short-term renewal problems.

1. A method of dividing archived data based on persistent queue (PQ) include:
i) divide said archived data into persistent data queues corresponding to the time needed for processing in the future;
ii) scheduling the processing of data that has been divided into these persistent data queues corresponding to future milestones; and
iii) redistributing archived data into new persistent data queues corresponding to the next time it takes to process this data.
